(19) United States
(12) Patent Application Publication
(10) Pub. No.: US 2025/0316824 A1
(43) Pub. Date: Oct. 9, 2025

(54) Cell separating element with mount, battery arrangement and method for producing a cell separating element

(71) Applicants: AUDI AG, Ingolstadt (DE); Volkswagen Aktiengesellschaft, Wolfsburg (DE)

(72) Inventors: Michael ERNST, Wüstenrot (DE); Jürgen GERBRAND, Kirchberg an der Murr (DE); Markus GRETZER, Eichstätt (DE); Johann HESSE, Augsburg (DE); Nicole KÄSSMANN, Gaimersheim (DE); Markus THURMEIER, Adlkofen (DE); Herr Gert Christian VOIGT, Usingen (DE); Jan-Philipp WEBERPALS, Abstatt (DE); Stephan KOHLITZ, Wolfsburg (DE); Özgür AKTAS, Salzgitter (DE)

(73) Assignees: AUDI AG, Ingolstadt (DE); Volkswagen Aktiengesellschaft, Wolfsburg (DE)

(21) Appl. No.: 19/170,651

(22) Filed: Apr. 4, 2025

(30) Foreign Application Priority Data
Apr. 5, 2024 (DE) 10 2024 109 554.7

(51) Int. Cl. H01M 50/291; H01M 50/209

(52) U.S. Cl. CPC H01M 50/291; H01M 50/209

(57) ABSTRACT

A cell separating element is for arrangement at a prismatic battery cell. The cell separating element includes a first wall and a second wall opposing the first wall, between which a cavity filled or fillable with a fluid is formed to provide a pad filled or fillable with the fluid. The cell separating element divides into a pad area and a cell separating element peripheral area surrounding the pad area in closed manner in a circumferential direction, in which the first wall and the second wall are connected to each other. A first part of a first peripheral area of the first wall is formed as an attachment flap to attach the cell separating element to the battery cell and is arranged angled at an angle (a) to a second part of the first peripheral area adjoining to the pad area and situated in a pad plane of the pad.

### CROSS-REFERENCE TO RELATED APPLICATIONS

This application claims the priority benefit of German Patent Application No. 10 2024 109 554.7 filed on Apr. 5, 2024, which is incorporated by reference herein in its entirety.

### BACKGROUND

### 1. Field

Examples of an invention relate to a cell separating element for arrangement in a prismatic battery cell. Furthermore, the examples of the invention also relate to a battery arrangement with such a cell separating element and to a method for producing a cell separating element.

### 2. Description of the Related Art

In high-voltage batteries of electrically operated vehicles, lithium-ion cells in different pack forms, like round cells, prismatic cells, also called cans, or pouch cells, are often predominantly used. Often, cell separating elements are positioned between the cells to take over various tasks in combination with the cell. These tasks for example include the so-called swelling compensation: By electrochemical processes, the volume of the active material in the foil wrap or foil stack of a battery cell increases. This volume increase is referred to as swelling. A defined pressure on the cells by the cell separating element is advantageous to allow controlled swelling of the cells. Unrestrained swelling as well as completely suppressed swelling result in a reduced lifetime. A further function relates to the so-called thermal propagation in case of a thermal runaway of a battery cell. Therein, it is advantageous if cell separating elements are installed between the cells, which provide a thermal insulation for example in the manner that a runaway cell is thermally insulated as far as the adjacent cells do not also catch fire or get in thermal runaway. A further function can also be tempering the cell. Basically, cells can be tempered via thermal connection to a heating and/or cooling circuit to satisfy the full functionality and the lifetime requirements. The thermal connection of the cell can be effected via the cell bottom and/or cell lid or via cell separating elements.

In the previous types of construction of cell separating elements, the above described functions are to be achieved by the employment of multiple components or cannot be implemented in the sought peculiarity. Thereby, a partially severely increased material usage is required. This adversely affects the required installation space, the weight, the manufacturing and mounting effort and the arising material cost.

Therefore, it would be desirable to be able to integrate as many of the above mentioned functions as possible in a cell separating element in as efficient and installation space saving manner as possible.

Heretofore, the formation of a cell stack also proves to be relatively expensive since the battery cells and cell separating elements have to be alternatingly stacked and then clamped to each other or have to be arranged in a common housing. In order to therein keep the cell separating elements in position, they are often adhered to the battery cells. However, this in turn impedes the disassembly of such a cell stack. Herein, the placement of such a cell separating element in its position to be adhered additionally proves to be very difficult.

DE 10 2010 012 932 A1 describes a battery with a stack of battery cells, which are formed as self-contained flat cells with an insulating sheathing and led-out electrical poles. Therein, the stack is alternatingly stacked of battery cells and respectively at least one intermediate sheet, wherein the intermediate sheet is connected to at least one of the electrical poles of at least one of the adjacent battery cells. Therein, the intermediate sheets can be connected to the electrical poles by means of soldering, welding, clamping or crimping. Therein, the intermediate sheet serves as a large-area battery pole, which can be simply and fast contacted. In addition, a heat conduction can be provided via the intermediate sheet to better equalize temperatures within the battery cells.

Neither a swelling compensation nor a thermal barrier can be presented via such an intermediate sheet.

### SUMMARY

An example object of the present invention may be to provide a cell separating element, a battery arrangement and a method, which allow providing a cell separating element for thermally shielding two battery cells and for swelling compensation with as few individual parts as possible and a manufacture of a cell stack as efficient as possible.

The example object may be solved by a cell separating element, a battery arrangement and a method with the features according to the respective independent claims. Advantageous configurations of the examples of the invention may be the subject matter of the dependent claims, the description as well as the figures.

A cell separating element according to the examples of the invention for arrangement at a prismatic battery cell includes a first wall and a second wall opposing the first wall, between which a cavity filled or fillable with a fluid is formed, whereby a pad filled or fillable with the fluid is provided. Therein, the cell separating element divides into a pad area and a cell separating element peripheral area surrounding the pad area in closed manner in a circumferential direction, which delimits the pad in and opposite to a first direction and in and opposite to a second direction, and which includes a first peripheral area of the first wall and a second peripheral area of the second wall. Furthermore, the first wall and the second wall are connected to each other in the cell separating element peripheral area. Moreover, a first part at least of the first peripheral area is formed as an attachment flap and arranged angled at an angle to a second part of the first peripheral area adjoining to the pad area, wherein the cell separating element can be retained on or attached to the battery cell by means of the attachment flap.

By the formation with a pad, many advantageous functions can be integrated in the cell separating element, as they will be explained in more detail below. In particular, the cell separating element can hereby be configured with very good thermally insulating characteristics as well as with very good swelling compensation characteristics as well as with an optional cooling function. However, it is now particularly advantageous that extremely few components are required for providing such a cell separating element and an additional retaining or attaching function without additional components can be additionally integrated in the cell separating element, namely for example by slightly extended configuration of at least one peripheral area of a wall of the cell separating element and correspondingly reshaping, for example bending, this part, which is presently referred to as first part of the first peripheral area and provides a corresponding attachment flap. Thus, the cell separating element can be formed of two walls, which are joined to each other in the cell separating element peripheral area, and the peripheral areas of which or at least one of the peripheral areas of the walls can be used to provide a retaining function for the cell separating element by an angled configuration. Thereby, the cell separating element can be advantageously retained, e.g. clipped, on a prismatic battery cell in force-fit and/or form-fit manner. This mount provided by the attachment flap can serve as a positioning aid on the one hand, to for example arrange the cell separating element at the prismatic battery cell accurately in position. The angled configuration of the first peripheral area can thus serve as a stop angle, to allow such a positioning. In addition, this mount also allows a simplified assembly of a cell stack. Thereby, the cell separating element for example does not have to be adhered to a battery cell anymore to allow a simpler assembly or simpler stacking and therein retain the cell separating element in position. Instead, this function can now also be taken over by the attachment flap. In addition, further functions can also be integrated in the attachment flap, for example a spacer function and/or a mechanical coupling function for coupling multiple cell separating elements to each other, as it will be explained in more detail later. Hereby, the mechanical stability of a cell stack overall can still be considerably increased.

The walls of the cell separating element, in particular at least one of the walls or both walls, can be formed shell-shaped. Therein, the first wall and/or the second wall can be respectively formed with an elevation or convex bulge opposite to each other in the pad area. Thereby, the cavity between the two walls is provided in the central pad area. For example, the two walls can be realized by two deep-drawn plates or foils. They can be configured deep-drawn opposite to each other in their respective central areas such that a cavity is formed in the central area between the two walls. It is also conceivable that one of the walls is flatly formed and only the other one with a corresponding shell-shaped geometry.

For example, the pad can be configured such that such a fluid, generally a liquid and/or a gas such as for example air, is permanently enclosed in the cavity. However, it can also be configured capable of being passed by such a fluid. For this purpose, a coolant supply and discharge connection can for example be provided at the pad. In both cases, it can be accomplished to generate a certain pressure in the cavity by the fluid. If the cell separating element is arranged between two cells, which swell due to their swelling characteristics, the pad can advantageously be at least partially compressed. Thus, the pad is at least partially compressibly formed. With increasing compression, therein, the counterforce generated by the fluid in the cavity can be increased. In particular, the pad can also be elastically deformable, in particular in the state filled with the fluid. Thereby, especially breathing of the cells, i.e. cyclic swelling and subsiding of the cells depending on state of charge, which can also be called charge-related swelling, can be very well compensated for. Thereby, the pad can very well adapt to the cyclic swelling and subsiding of the cells by a corresponding, elastic variation of its thickness. In addition, if a gas is in the cavity of the pad as the fluid, thus, very good thermal insulating characteristics of the cell separating element can in particular be provided hereby. In addition, a thermal runaway of a battery cell, which adjoins to the cell separating element, for example causes heating of the fluid located in the cavity, in particular gas, whereby it expands and can thereby distance the thermal runaway cell from its neighbor cells. Thus, many advantageous characteristics can be advantageously combined in one cell separating element.

In the following, reference is partially made to different directions for simplified description. Therein, they are to be defined as follows: Therein, the cell separating element has a length of the first direction, a width of the second direction and a thickness in a third direction. Therein, the first wall opposes the second wall with respect to the third direction. Therein, the thickness of the cell separating element or of the pad is also defined in the third direction. In an intended arrangement of the cell separating element in a cell stack with multiple battery cells arranged next to each other in stacking direction, which can for example be formed as pouch cells and/or prismatic battery cells, the third direction may also correspond to the stacking direction.

Basically, the pad can have any geometry and for example also be circularly formed. However, the geometry of the pad is configured to the geometry of the battery cells, between which the pad is to be arranged. Therein, the pad may be arranged between cells, which are formed as prismatic battery cells. These battery cells typically have a substantially rectangular side surface viewed perpendicularly to the stacking direction. Correspondingly, in an example, the pad also has a rectangular geometry. Correspondingly, in an example the first wall as well as the second wall or at least the wall sections delimiting the pad each have a rectangular geometry. Furthermore, in an example, the above defined first, second and third directions are perpendicular to each other. In other words, in an example, the first direction is to be perpendicular to the second and the third direction as well as the second direction is to be perpendicular to the third direction.

Furthermore, it is very advantageous if a length and width of the cell separating element and of the pad are considerably larger than a thickness of the cell separating element or of the pad in the third direction, in particular by at least a factor of 10. Therein, the length and width can be generally several centimeters, while the thickness of the cell separating element or of the pad is e.g. maximally 15 mm or less at the thickest location.

Therein, the thickness of the pad in the third direction can be substantially constant in the uninstalled state of the cell separating element, that is without additional external force application, except for a prevailing ambient pressure corresponding to standard conditions, across the pad, i.e. in the extension in the first and/or second direction, or can for example vary in the extension in the first and/or second direction.

The cell separating element peripheral area can include a first peripheral area of the first wall, which surrounds the first central area of the first wall and delimits the first wall on both sides with respect to the first and the second direction. In addition, the cell separating element peripheral area can include a second peripheral area of the second wall, which surrounds a second central area of the second wall and delimits the second wall on both sides with respect to the first and the second direction. In other words, the first and the second wall can thus also each be divided into a central area and a peripheral area surrounding this central area in closed manner, which delimits the concerned wall both in the first direction and in the second direction on both sides.

If a fluid is enclosed in the pad or the cavity thereof, or if the pad is passed by a fluid in the operation, thus, the pad can have a compressed and an uncompressed state, wherein the fluid in the cavity in the uncompressed state can have a positive pressure with respect to an ambient pressure or can have a pressure, which corresponds to an ambient pressure or a normal pressure in predetermined standard conditions. In the compressed state of the pad, the fluid in the cavity has an increased pressure with respect to an ambient pressure.

Optional connections, for example a coolant supply connection and a coolant discharge connection, can be arranged in the cell separating element peripheral area of the cell separating element. Hereby, an additional cooling function of the cell separating element can be provided. However, it is particularly advantageous if the pad is configured such that the fluid is enclosed in the cavity of the pad. In this case, the pad does not have to be provided with connections. The fluid can be enclosed in the cavity during the manufacture of the pad. Thereby, the pad does not have to be provided with interfaces for subsequent filling of the cavity with a fluid. Thus, it is very advantageous if the cavity of the pad is filled with a fluid, for example a liquid and/or a gas, and the two walls are fluid-tightly joined in the cell separating element peripheral area by the closed circumferential join connection. Thus, the first peripheral area of the first wall can be fluid-tightly joined to the second peripheral area of the second wall in closed circumferential manner. Thus, the join connection can be realized along a closed circumferential join contour in this case.

The pad can e.g. be permanently filled with a gas as the fluid. Such a gas-fluid pad has the great advantage as the cell separating element that thereby accurately adjustable pressure conditions can be provided as a counterforce of the cell, perfect elastic characteristics can be provided over the lifetime by the gas filling, additionally, very good insulating characteristics can be provided by the gas buffer between the cells. Furthermore, an additional expansion of the gas buffer in the pad upon thermal runaway of a cell can effect an even better insulation by the volume increase of the gas as a result of the high temperature increase, and thus pressing the hot cell away from the cells to be protected can be achieved. Thus, a safety mechanism in case of thermal runaway of a battery cell can be additionally integrated by the gas-filled pad.

Therein, an area is to be understood by a closed circumferential cell separating element peripheral area, which extends along a closed peripheral contour, e.g. around a center of the respective and second wall related to the first and the second direction. In case of a rectangular pad or in case of rectangular sidewalls, the closed circumferential cell separating element peripheral area is correspondingly also rectangular. In case of a round pad, for example, the cell separating element peripheral area would correspondingly also be round. Therein, the cell separating element peripheral area can include a periphery or an edge of the concerned wall, for example the upper and lower as well as also the left and the right periphery of the first wall and the second wall, respectively, but does not have to be restricted to this periphery, but can extend towards the center of the concerned wall to certain extent. For example, the cell separating element peripheral area and correspondingly also the first and the second peripheral area of the respective two walls can extend towards the center starting from the periphery of the respective wall by a length, which may also be only a few centimeters or millimeters, for example maximally 30 millimeters or maximally 20 millimeters or maximally 10 millimeters.

In an example, the first and the second wall further directly adjoin to the cavity delimited by them. In addition, the cavity is exclusively delimited by areas of the first and the second wall. A pad peripheral area, which circumferentially delimits the pad or the cavity perpendicularly to the third direction, is correspondingly also provided by areas of the first and/or the second wall, namely by the areas, which are located between the cavity and the environment of the pad viewed perpendicularly to the third direction. Thus, the pad peripheral area adjoins to the cavity perpendicularly to the third direction and surrounds it, and the cell separating element peripheral area in turn circumferentially adjoins to the pad peripheral area viewed perpendicularly to the first direction. In particular, the first and the second wall can be the only constituents of the cell separating element. In particular the pad thereby does not have further elements delimiting the cavity.

In addition, in an example, the cavity is a contiguous cavity. Alternatively, the cavity can also be divided into individual partial spaces, which are separated from each other or not fluidically connected to each other. In an intended arrangement of the cell separating element between the two battery cells, a major part of the clearance between the two battery cells is e.g. filled with the pad area of the cell separating element, which includes the cavity as the only cavity of the pad area. Thus, the pad area or the cavity is not divided or separated into individual smaller cavities.

By the join connection, this cavity can be hermetically closed. The walls are inherently also airtightly or gas-tightly formed and do not comprise, at least if the pad is formed as a pressure pad filled with the fluid, in which the fluid is permanently accommodated and enclosed in the cavity, an interface or valves or the like, to supply gas or another fluid to the pad or discharge it from it, at least not without impairing the function of the pad or destroying it. Filling the cavity with the fluid can thus be effected already before or during the joining operation for joining the two peripheral areas of the first and the second wall, and does not have to be effected afterwards.

That the first part of the first peripheral area is formed as an attachment flap, means that this attachment flap is an integral constituent of the first wall. Thus, the attachment flap is formed of a part of the first wall, for example by reshaping, such as for example bending or folding or the like. This allows a particularly simpler manufacture of the cell separating element and a simpler integration of such a retaining function since an additional separate component for forming such an attachment flap is not required.

Therein, the attachment flap can be configured single-walled or also double-walled. In other words, the attachment flap can be composed only of the first part of the first peripheral area of the first wall or the attachment flap can additionally also include a corresponding first part of the second peripheral area of the second wall, which is analogously arranged angled at an angle to a second part of the second peripheral area of the second wall adjoining to the pad area and situated in a pad plane of the pad. The two first parts of the first and the second peripheral area can for example flatly abut on each other and collectively provide the attachment flap. The single-walled configuration of the attachment flap is weight- and material-saving. By the double-walled configuration of the attachment flap, the stiffness and strength thereof can be increased.

That the first part of the first peripheral area is arranged angled to the second part of the first peripheral area, is therein in particular to be understood such that there is an angle different from 180° between the first and the second part. Thus, the first and the second part, which are in particular to be construed as flat elements, are not in a common plane. Moreover, the second part can be in a pad plane of the pad or in a plane or parallel to a plane, which can be spanned by the first and the second direction. Thus, the pad plane can also be oriented parallel to a plane, which is spanned by the above mentioned first and second direction. Related to an intended arrangement of the cell separating element in a cell stack with multiple prismatic battery cells arranged next to each other in a stacking direction, the pad plane can thus be oriented substantially perpendicularly to the stacking direction.

According to a further advantageous configuration of the examples of the invention, the first part of the first peripheral area is arranged angled such that, when the pad area of the cell separating element is arranged on a first housing side of the battery cell, the first part of the first peripheral area can be flatly abutted or placed on a second housing side of the battery cell adjoining to the first housing side. In other words, if the cell separating element is arranged on the prismatic battery cell as intended, thus, the pad area of the cell separating element is arranged on the first housing side of the battery cell, which may represent one of the two housing sides of the prismatic battery cell largest in terms of surface, and the first part of the first peripheral area, which thus provides the attachment flap, flatly abuts on the second housing side of the battery cell. For example, the first part of the first peripheral area can have an angle of ca. 90 degrees in relation to the second part of the first peripheral area, for example +/−10 degrees or +/−5 degrees. As explained in more detail below, the cell separating element can also include multiple such attachment flaps. They can for example be arranged opposing to provide some kind of clamping function. The angle between the first part of the first peripheral area and the second part of the first peripheral area can then for example be slightly less than 90 degrees. By fitting the cell separating element to the battery cell, a correspondingly slight bending up or bending of the first part with respect to the second part can be provided, in particular elastic bending, wherefrom a certain contact force of the first part on the second housing side results. The same also applies to the opposing attachment flap.

According to a further advantageous configuration of the examples of the invention, the cell separating element includes multiple attachment flaps. They can include the already mentioned attachment flap. In addition, the multiple attachment flaps or the in particular at least one further attachment flap can be formed similarly as already described to the at least one attachment flap and also explained below. In other words, the features described previously and below with respect to the attachment flap are also to be able to apply to all further optional attachment flaps of the cell separating element. The respective attachment flaps can each be formed as a first part of the first and/or second peripheral area, in particular wherein the cell separating element for example includes a first and a second attachment flap, which are arranged on opposing sides of the pad with respect to the first direction or the second direction. Thereby, the above mentioned clamping function can for example be realized in simpler manner. For example, the cell separating element can also include three or four attachment flaps. These third and fourth attachment flaps can also be opposing. Generally, such an attachment flap can be provided as a part of the cell separating element peripheral area on one, on two, three or four sides of the pad.

According to a further advantageous configuration of the examples of the invention, the first part of the peripheral area is as wide as the second part of the peripheral area. In this case, the first part of the peripheral area, thus the attachment flap, can thus extend substantially across the entire width of the pad or the cell separating element, for example related to the first direction or related to the second direction, according to arrangement of the attachment flap. For example, the corresponding peripheral area can be simply configured slightly longer in a desired direction and bent to provide the attachment flap. Then, cutting or the like of the peripheral area is not required. However, it is also conceivable that the first part of the peripheral area is less wide than the second part of the peripheral area. Hereby, a correspondingly narrower attachment flap can thus also be provided. Thus, it does not have to extend across the entire width of the cell separating element or of the pad. This for example also allows providing multiple attachment flaps on a same side of the pad.

The wide configuration of the attachment flap has the advantage that a large part for example of an edge of the cell housing and/or of the second housing side can be covered and overlaid by the attachment flap. This additionally offers protection for the battery cell, especially in case of outgassing of the battery cell or a further battery cell. Even if the battery cell itself outgases, for example via a cell degassing opening provided in the second housing side, for example a bursting diaphragm, the probability of a damage or fracture of the second housing side caused by the exiting hot gases can be minimized to greatest extent by the covering attachment flap. In such a case, the attachment flap may be configured such that at least one such cell degassing opening capable of being unblocked is not covered by the attachment flap.

According to a further advantageous configuration of the examples of the invention, the at least one attachment flap includes a first locking element, which, when the pad area of the cell separating element is arranged on a first housing side of the battery cell, can be lockingly coupled to a corresponding second locking element of a second housing side of the battery cell adjoining to the first housing side. For example, the attachment flap can be formed with a locking lug as such a first locking element and the second housing side of the battery cell comprises a corresponding notch, with which the locking lug can be engaged. Instead or in addition, the second housing side can also be configured with such a locking lug and the first locking element is configured as a corresponding recess or notch in the attachment flap. Thereby, the attachment flap can advantageously lock onto the battery cell, in particular on the second housing side thereof. Thus, the attachment flap and in particular the entire cell separating element can be even more reliably fixed to the battery cell.

Therein, such a locking element can be located at a flap end of the attachment flap, but which does not necessarily have to be the case. Such a locking element can be formed as a local locking element at the attachment flap. Thereby, it can for example be realized that a shift of the attachment flap in relation to the battery cell in a plane, in which the second housing side is also situated, is not possible. Overall, the cell separating element can thus be fixed in relation to the battery cell in three spatial directions, e.g. in combination with a further flap on the opposing side, which abuts on and/or is clipped into a housing side of the cell housing opposing the second housing side.

According to a further advantageous configuration of the examples of the invention, the at least one attachment flap is formed with a spacer at a flap end, in particular wherein the attachment flap, when the pad area of the cell separating element is arranged on the first housing side of the battery cell, protrudes beyond the battery cell in the third direction. The cell separating element can for example form a battery cell unit in combination with the battery cell. By the formation of the attachment flap with a spacer at the flap end, a defined minimum distance to the next battery cell unit in stacking direction can be ensured. In other words, multiple thus provided battery cell units can be arranged next to each other, in particular on each other, in stacking direction for forming a cell stack, wherein the spacer of a respective cell separating element ensures a certain minimum distance between two battery cell units and thereby also between two battery cells in stacking direction. Such a spacer in turn has great advantages especially in combination with the formation of the cell separating element with a pad fillable or filled with the fluid or gas, since for example flattening of the pad caused by swelling can hereby be prevented. However, such a spacer can also be differently realized, for example via a different embossment of the first and/or second wall of the cell separating element, as explained in more detail later.

Basically, the spacer can be already realized in that the attachment flap, when the pad area of the cell separating element is arranged on the first housing side of the battery cell, protrudes beyond the battery cell in the third direction. However, it is particularly advantageous if the flap end is therein formed in an additional, certain geometry, for example bent and/or folded and/or curved and/or bent or folded multiple times or comprises a groove pattern. Thereby, the stiffness and robustness of the spacer can be increased.

According to a further advantageous configuration of the examples of the invention, the spacer is formed as a hook folded on the end side, which encompasses onto a third housing side of the battery cell, which adjoins to the second housing side and opposes the first housing side, in case of arrangement of the pad area on the first housing side. By such a hook-shaped formation, the retaining function of the cell separating element can be additionally stabilized on the one hand, since encompassing onto the third housing side of the battery cell is allowed hereby. The cell separating element can, especially if it includes multiple such attachment flaps, for example two opposing attachment flaps, be simply clipped onto the battery cell, wherein the attachment flaps encompass and snap around the battery cell on the end side. The formation as a folded hook additionally has the great advantage that such a hook can in turn be provided in simpler manner without additional components by reshaping of the attachment flap. Therein, the hook can also be formed folded or bent multiple times such that it is formed all the thicker in the third direction. Thereby, the spacer function can be in turn provided by the hook at the same time in simpler manner.

Moreover, the flap end, in particular the spacer, can also be formed as a spring element. The flap end, in particular the spacer, can thus be elastically flexible in the third direction. Thereby, a tolerance compensation for different distances to neighbor cells or the cell separating elements arranged on them can be advantageously provided. Such a spring function can e.g. also be realized by some kind of hook geometry of the flap end. It can e.g. be bent multiple times, e.g. to a V-shaped geometry or some kind of zigzag geometry.

However, such a hook does not necessarily have to function as such a spacer, but can additionally or alternatively also satisfy another function.

Correspondingly, it represents a further advantageous configuration of the examples of the invention if the cell separating element comprises a third locking element for locking connection to a locking element with a certain locking geometry and the attachment flap comprises a fourth locking element with the certain locking geometry at the flap end for locking to a further similar cell separating element. This fourth locking element can for example also be formed as the above described, folded hook, in particular folded multiple times. Optionally, the fourth locking element can also function as a spacer. In the present case, the fourth locking element takes over the function to be able to lock battery cell units arranged next to each other to each other, in that the respective cell separating elements can be locked into each other. Thereto, each of the cell separating elements thus comprises a third and a fourth locking element corresponding thereto. Therein, the fourth locking element is advantageously arranged at the flap end of the attachment flap. Therein, the attachment flap may also be configured such that it protrudes beyond the battery cell in the third direction when the cell separating element is arranged at the battery cell as intended. Thereby, the flap end with the fourth locking element can be hooked into or locked to the cell separating element of the next battery cell unit in simpler manner. The locking element can also be resiliently configured. Therein, the third locking element can also be in the peripheral area or for example also in the shell periphery of the pad. Individual battery cell units can thus be mechanically fixed to each other.

Herein too, the locking elements can for example again be locking lugs and/or V-shaped bending geometries and corresponding recesses or notches or any other locking geometries corresponding to each other.

In addition, these locking elements, namely the third and the fourth locking element, can be provided in addition to the above described first locking element.

Furthermore, the cell separating element can have further advantageous features, as they are described e.g. in co-pending applications of the same applicants, filed at the German Patent and Trademark Office at the same day as the present application, entitled “Cell separating element with integrated cooling channel, battery module, battery and method for producing a cell separating element,” patent application no. DE 10 2024 109 571.7; “Cell separating element with integrated structural pattern, as well as battery module with such a cell separating element,” patent application no. DE 10 2024 109 572.5;” and “Cell separating element with integrated spacer, battery module and method for producing a cell separating element,” patent application no. DE 10 2024 109 557.1,” for example, respectively in claims 1 to 10 of the co-pending applications, and which contents of the co-pending applications are incorporated by reference herein.

An outer side of the first and/or second wall can be formed with a first depression in the central pad area, which includes a first end and a second end, which each join into a shell periphery of the pad. The depression can be formed as a first structure embossed in the first and/or second wall on the outer side, in particular as a groove, e.g. linearly extending groove. The second wall can be formed corresponding to the first wall or only the second wall can be formed as described to the first wall. The first and/or the second wall can comprise multiple such grooves, they can extend parallel to each other and/or intersect each other at an angle, e.g. perpendicularly, and form a groove grid. With respect to the intended installation position in a cell stack, between the first and/or second outer side and a cell wall of a battery cell of the battery module adjoining to the first and/or outer side, a cooling channel capable of being passed by a coolant is formed by the depression of the first outer side, through which a coolant, e.g. air, can be conveyed. This one or these multiple depressions or grooves can be a part of the structural pattern or the structural element thereof described below.

Additionally or alternatively, the first and/or the second wall can have an embossed, depressed structural pattern with at least one embossed, depressed structural element, wherein the structural pattern, when the pad is compressed such that the at least one structural element has contact with an inner side of the second or first wall adjoining to the cavity, is elastically deformable and/or plastically deformable such that a cavity volume of the cavity increases by a plastic deformation of the structural pattern. The at least one structural element can be formed such that it is elastically deformable or more severely elastically than plastically deformable below a certain limit pressure and plastically deformable or more severely plastically than elastically deformable above the limit pressure, and/or wherein the structural pattern includes a first structural element and a second structural element as the at least one structural element, which are configured such that the first structural element is substantially only elastically deformed below a certain limit pressure and the second structural element is substantially only plastically deformed above the limit pressure. A first structural element can be stiffer than a second structural element of the structural pattern and/or be more or less deeply embossed. The structural pattern can be formed with a varying maximum structural depth. The second or first wall can comprise an embossed, depressed second structural pattern with at least one embossed, depressed third structural element, which directly opposes the at least one structural element of the first or second wall. Thus, structural elements of the first and the second wall can directly oppose each other. The structural pattern can include an elongated, groove-shaped depression as the at least one structural element, in particular wherein the structural pattern comprises multiple groove-shaped depressions forming a grid structure, which divide the first and/or second wall into multiple segments, in particular rectangular segments, in the pad area. Additionally or alternatively, the structural pattern can comprise a local embossment as the at least one structural element, which comprises a center, which defines a deepest location of the embossment, wherein the embossment includes an area, which encompasses the center and in which a depth of the embossment decreases with increasing distance from the center. The structural pattern can include multiple embossments, wherein the outer side of the first and/or second wall can be divided into multiple segments by the above mentioned groove grid and one of the embossments can be arranged in a respective segment.

In particular, the cell separating element peripheral area can comprise a structure, which is formed by at least one reshaping of the cell separating element peripheral area and by which a spacer supporting with respect to the third direction is provided, in at least one section of the cell separating element peripheral area different from the attachment flap. Thus, such a spacer can be provided additionally or alternatively to the spacer capable of being provided by the above described flap end. The structure extends along the circumferential direction, e.g. along the entire cell separating element peripheral area surrounding the pad or only over one or more partial areas of the cell separating element peripheral area, in particular over two partial areas, which are opposing each other with respect to the first direction or with respect to the second direction. In addition, the structure can be formed such that a pressure relief and/or stabilization of the join connection is provided by it in case of force application to the pad on both sides from the outside with respect to the third direction, in particular wherein the structure is formed such that the first and the second wall are pressed onto each other in a pressing area of the cell separating element peripheral area upon force application to the spacer on both sides with respect to the third direction, wherein the join connection is in the pressing area, and/or the pressing area is closer to the central pad area than the join connection. The join connection can also be closer to the central pad area than the pressing area. The reshaping of the cell separating element peripheral area can be provided by bending and/or beveling and/or crimping at least one section of the first and/or second peripheral area, in particular by oppositely bending and/or beveling and/or crimping the first and the second peripheral area facing away from each other, e.g. in areas, in which the attachment flap is not located. The reshaping of the cell separating element peripheral area can also be provided by an embossment of the first and/or second wall in the cell separating element peripheral area, in particular by a mirror-symmetric embossment structure in the first and the second peripheral area. The first and/or the second peripheral area can also be formed with a corrugation structure and/or bead structure and/or groove structure, in particular as the structure or in addition to the structure. Furthermore, at least the first peripheral area can be formed with an elongated first elevation convexly configured with respect to the third direction, which completely or partially extends around the first central area of the first wall in the circumferential direction, wherein an elastic groove is in particular between the first central area of the first wall and the first elevation, in particular wherein the second peripheral area is additionally formed with an elongated second elevation convexly configured with respect to the third direction, which directly opposes the first elevation with respect to the third direction, and which completely or partially extends around the second central area of the second wall in the circumferential direction, wherein a further elastic groove is in particular located between the second central area of the second wall and the second elevation.

Furthermore, the examples of the invention also relate to a battery arrangement with a cell separating element according to the examples of the invention. Moreover, the battery arrangement can also comprise a battery cell, in particular a prismatic battery cell. Therein, the cell separating element can be able to be retained on or attached to the battery cell in force-fit and/or form-fit manner by means of the attachment flap. For example, the cell separating element and the battery cell can form a battery cell unit as it has been defined above.

Moreover, the battery arrangement can also comprise a cell stack with multiple battery cell units arranged next to each other in stacking direction.

For the rest, the battery arrangement can be formed as already described in context of the cell separating element according to the examples of the invention.

Furthermore, the examples of the invention also relate to a battery with a battery arrangement according to the examples of the invention.

For example, the battery cells can be formed as lithium-ion cells or as battery cells with any other cell chemistry. Furthermore, the battery cells can for example be formed as prismatic battery cells. Moreover, the battery cells can be in wrap or stack technology, that is with an electrode arrangement in the cell interior, which may be configured as an electrode wrap or as a layered or stacked electrode arrangement. The battery or the battery arrangement can be formed as a high-voltage battery. In this example, the battery can also include multiple battery arrangements, e.g. in the form of battery modules. However, the battery or the battery module can also be formed as a medium-voltage battery or low-voltage battery. Moreover, the battery can be applied in a motor vehicle, but also in other areas outside of a vehicle, for example be formed as a stationary battery or be used in a battery-operated product, for example electric tools, and so on.

Furthermore, the examples of the invention also relate to a motor vehicle with a battery according to the examples of the invention. The battery can represent a traction battery of the motor vehicle.

The motor vehicle according to the examples of the invention may be configured as an automobile, in particular as a passenger car or truck, or as a passenger bus or motorcycle.

Furthermore, the examples of the invention also relate to a method for producing a cell separating element for arranging at a prismatic battery cell, wherein the cell separating element is formed with a first wall and a second wall opposing it, between which a cavity filled or fillable with a fluid is formed, whereby a pad filled or fillable with the fluid is provided. Therein, the cell separating element divides into a pad area and a cell separating element peripheral area surrounding the pad area in closed manner in a circumferential direction, which delimits the pad in and opposite to the first direction and in and opposite to a second direction, and which includes a first peripheral area of the first wall and a second peripheral area of the second wall. Furthermore, the first wall and the second wall are connected to each other in the cell separating element peripheral area. In addition, a first part of the first peripheral area is formed as an attachment flap and formed angled at an angle to a second part of the first peripheral area adjoining to the pad area, wherein the cell separating element can be retained on or attached to the battery cell by means of the attachment flap.

The advantages described for the cell separating element according to the examples of the invention similarly apply to the method according to the examples of the invention.

The angled formation of the first part with respect to the second part can be effected by reshaping at least the first peripheral area, e.g. bending or folding or beveling.

Developments of the method according to the examples of the invention, which comprise features, as they have already been described to the developments of the cell separating element according to the examples of the invention and of the battery arrangement according to the examples of the invention, also belong to the invention. For this reason, the corresponding developments of the method according to the invention are not again described here.

The invention also includes the combinations of the features of the described examples. Thus, the invention also includes realizations, which each comprise a combination of the features of multiple of the described examples if the examples have not been described as mutually exclusive.

### BRIEF DESCRIPTION OF DRAWINGS

In the following, execution examples of the invention are described. Hereto, there shows:

FIG. 1 a schematic and perspective representation of a battery cell unit with a cell separating element and a battery cell according to an execution example of the invention;

FIG. 2 a schematic cross-sectional representation of a battery cell unit with a cell separating element according to an execution example of the invention;

FIG. 3 a schematic representation of an attachment flap for a cell separating element according to an execution example of the invention;

FIG. 4 a schematic representation of a further attachment flap in an uncompressed and a compressed state according to an execution example of the invention;

FIG. 5 a schematic representation of a further attachment flap with locking function according to an execution example of the invention; and

FIG. 6 a schematic representation of a battery cell unit with a cell separating element according to a further execution example of the invention.

### DESCRIPTION

The described execution examples explained in the following are examples of the invention. In the execution examples, the described components of the examples each represent individual features to be considered independently of each other, which each may also develop the examples independently of each other. Therefore, the disclosure also is to include combinations of the features of the examples different from the illustrated ones. Furthermore, the described examples can also be supplemented by further ones of the already described features of the examples of the invention.

In the figures, identical reference characters each denote functionally identical elements.

The illustrated coordinate systems may be cartesian coordinate systems. Therein, the illustrated x-direction corresponds to the previously defined first direction, the illustrated y-direction corresponds to the previously defined third direction and the illustrated z-direction corresponds to the previously defined second direction.

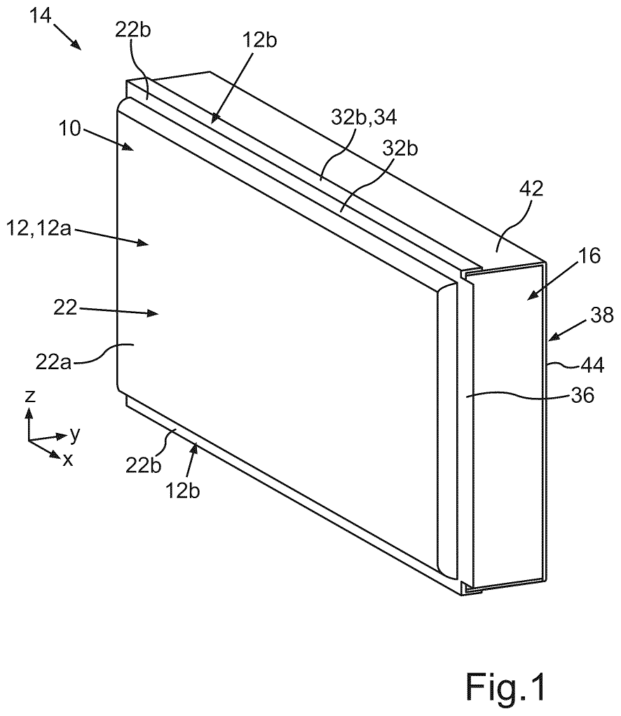

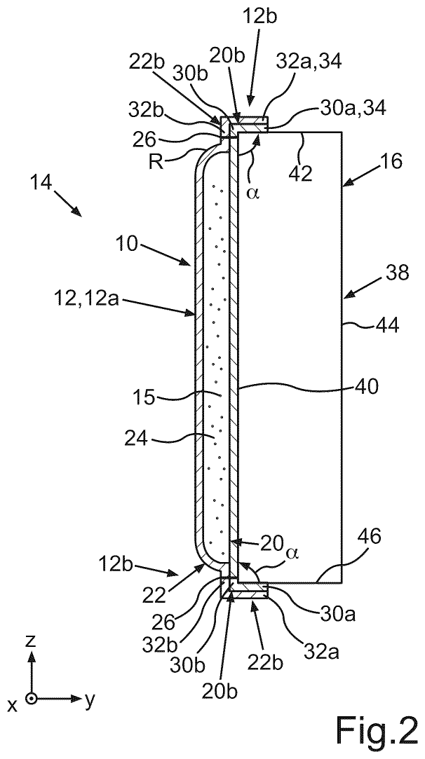

FIG. 1 shows a schematic and perspective representation of a battery cell unit 14 with a cell separating element 10 according to an execution example of the invention and a battery cell 16, which represents a prismatic battery cell 16. FIG. 2 shows a schematic cross-sectional representation of the battery cell unit 14 from FIG. 1. In the following, FIG. 1 and FIG. 2 are commonly described. The cell separating element 10 includes a pad 12, which comprises a cavity 24 filled with a fluid 15. The fluid 15 is presently a gas, for example air. The cell separating element 10 includes two walls, namely a first wall 20 and a second wall 22, between which the cavity 24 is formed, and which are joined to each other, for example welded to each other, in a peripheral area 12b, which is also referred to as cell separating element peripheral area 12b, surrounding the pad 12. The join connection is presently denoted by 26. The walls 20, 22 can for example be of a metallic material, for example steel or stainless steel. By a thin-walled configuration of the walls 20, 22, the pad is still flexible and in particular compressible with respect to the illustrated y-direction upon external force application.

Therein, the circumferential peripheral area 12b surrounds the pad 12, which correspondingly defines a pad area 12a of the cell separating element 10. The two walls 20, 22 can also be divided respectively into a central area 20a, 22a and a peripheral area 20b, 22b, which surrounds the respective central area 20a, 22a in closed circumferential manner. Therein, the pad area 12a of the cell separating element correspondingly includes the central area 20a, 22a of the first and the second wall 20, 22 as well as the cavity 24 formed between these walls 20, 22. The cell separating element peripheral area 12b correspondingly includes the two peripheral areas 20b, 22b of the respective walls 20, 22. In addition, one or both walls 20, 22 can be shell-like to enclose the cavity 24 between them. In the present example, the first wall 20 is flatly configured in the pad area 12b, but can also be shell-shaped corresponding to the second wall 22.

At least a first part 30a of the first peripheral area 20b is formed as an attachment flap 34 and arranged angled at an angle α to a second part 30b of the first peripheral area 20b adjoining to the pad area 12a and e.g. situated in a plane parallel to the pad plane of the pad 12. In this example, a first part 32a of the second peripheral area 22b is also formed as such an attachment flap 34 and arranged angled at a corresponding angle α to a second part 32b of the second peripheral area 22b adjoining to the pad area 12a and also situated in the pad plane or parallel to the pad plane of the pad 12. In this example, the respective first part 30a, 32a is angled by an angle α, which is substantially 90 degrees, with respect to the respective second part 30b, 32b. The two first parts 30a, 32a quasi form a common attachment flap 34. However, it would also be conceivable that such an attachment flap 34 is only formed by one of the two mentioned parts 30a, 32a. In addition, the cell separating element 10 comprises each one such flap 34 on two sides of the pad 12 opposing with respect to the z-direction in the present example. Optionally, the sections 36 of the peripheral area 12b, of which one such section 36 is visible in FIG. 1, can also be formed as such flaps 34, which are arranged on one side or both sides with respect to the pad 12 in and/or opposite to the x-direction. By such attachment flaps 34, a retaining possibility or attachment possibility for attaching the cell separating element 10 to the battery cell 16 can be advantageously provided.

Therein, the battery cell 16 comprises a substantially prismatic cell housing 38, which includes a first housing side 40, which represents one of the two housing sides largest in terms of surface, and on which the cell separating element 10, in particular the pad area 12a of the cell separating element 10, is presently arranged. In addition, the housing 38 includes a second housing side 42, which adjoins to the first housing side 40, a third housing side 44, which adjoins to the second housing side 42 and opposes the first housing side 30, as well as a fourth housing side 46, which adjoins to the first and the third housing side 40, 44 and opposes the second housing side 42. In addition, the housing 38 includes two further housing sides opposing each other with respect to the x-direction, but which are presently not provided with a reference character. Presently, the flaps 34 are formed such that they flatly abut on the second housing side 42 on the one hand and on the fourth housing side 46 on the other hand. In addition, the flaps 34 may be shorter with respect to the y-direction than the thickness of the battery cell 16 in the y-direction. Thereby, the flaps 34 do not completely cover the cell housing 38 in y-direction. In the present example, the flaps 34 are configured relatively shortly in y-direction and in particular do not reach up to the half of the cell 16 in y-direction. However, the flaps 34 can also be longer and cover a major part of the second and fourth side 42, 46, respectively, or the respective entire housing sides 42, 46 in y-direction.

The protruding flaps 34 of the cell separating element 10 are bent by ca. 90 degrees, whereby a U-shape arises in this example. However, only one, two, three or all ends, that is peripheral area sections of the peripheral area 12b, can also be bent. Generally, this allows a particularly simpler integration of a retaining function or enclosing function and thereby an integration of fixing of the cell separating element 10 to a prismatic battery cell 16. Thereby, e.g. an axially preset positioning on the cell housing 38 is possible. With corresponding configuration, the bending, that is for example the angle α among other things, can be such that the friction between the bent flaps 34 and the cell housing 38 is sufficiently great to retain such a cell separating element in its position after assembly and thus to simplify a further processing. Hereto, the angle α can be selected e.g. slightly less than 90 degrees and the flap 34 can be bendable or flexible by its low wall thickness.

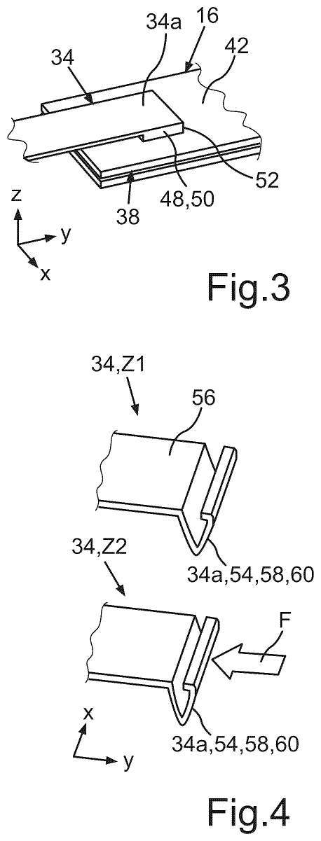

By additional geometric structures, such as for example in a snap connection, locking into recesses provided in the cell housing 38 can be additionally allowed, as it will be described below with reference to FIG. 3.

Therein, FIG. 3 shows a schematic representation of a flap 34 for a cell separating element 10 according to an execution example of the invention. Therein, the cell separating element 10 as well as the flap 34 thereof can be formed as previously described. In the present example, the flap 34 is exemplarily illustrated narrower in x-direction, but can be as wide as for example illustrated in FIG. 1. Alternatively, the cell separating element 10 can for example also be formed with multiple such narrow flaps 34, which are arranged next to each other on a same side of the pad 12 in a certain direction, for example in x-direction.

In the present example, some kind of locking lug 50 is formed at a flap end 34a with a locking element 48, which corresponds to a corresponding second locking element 52, which is presently arranged in the second housing side 42 of the cell 16. Therein, locking of the cell separating element 10 or the flap 34 thereof in the recess 52 in the cell housing 38 is in particular illustrated in FIG. 3, i.e. the flap 34 is in the locked state. This second locking element 52 can for example be formed as a corresponding depression or notch. It is also conceivable that the first locking element 48 is configured as such a recess or notch in the end area 34a of the flap 34, while the cell housing 38 is formed with a protruding locking lug or the like in particular on the second housing side 42 in this example. In this manner, the flap 34 can be locked in a side 42 of the cell housing 38 with its flap end 34a and be clipped to the cell housing 38. Such a locking connection can also be referred to as snap connection. In addition to the axial orientation, a fixedly fixed position of the cell separating element 10 on the cell housing 38 without additional material such as for example adhesive is advantageously also possible thereby.

According to a further example, the length of the bent leg, that is thus the length of the flap 34 in y-direction, can be dimensioned such that the flap 34 protrudes beyond or covers the complete thickness of the cell housing 38 in y-direction, as it is schematically illustrated in FIG. 4.

Therein, FIG. 4 in particular shows a schematic representation of a further example of an attachment flap 34 for a cell separating element 10, namely in a non-compressed, relaxed state Z1 in the representation at the top, and in a state Z2 partially compressed by a pressure force F in FIG. 4 at the bottom. In this example, the flap 34 is configured with some kind of hook 54 in its end area 34a, which is additionally elastic or resilient by its geometry. Therein, the end area 34a is in particular formed V-shaped. Therein, in the state of the cell separating element 10 on a battery cell 16 arranged as intended, the hook can encompass it on the third side 44 thereof. The flat area 56 of the flap 34 different from the hook 54 for example completely covers the second housing side 42 in y-direction and the hook area 54 protrudes beyond the cell 16 in y-direction. If multiple battery cell units 14 are arranged next to each other in y-direction, thus, this hook 54 comes to abutment in the battery cell unit 14 next in y-direction, in particular in the peripheral area 12b of the cell separating element 10 of the next battery cell unit 14. Thus, the contact force F can be effected by arranging on the next battery cell unit 14. By the resilient effect of the hook 54, a tolerance compensation in y-direction is advantageously provided. In addition, a spacer function can also be provided at the same time by the hook 54. In other words, the hook 54 can also function as a spacer 58 at the same time.

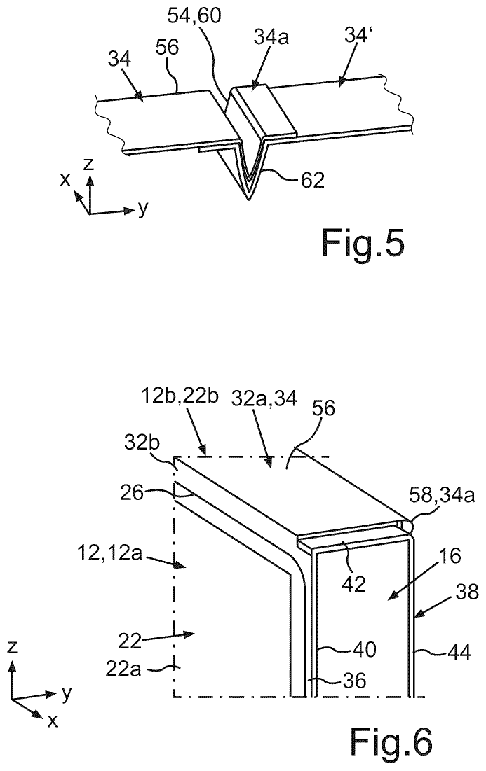

Alternatively or additionally, it is possible that a further locking element 60 (cf. FIG. 5) is provided by this hook 54 or another geometry, which can snap or lock into a corresponding locking element 62 (cf. FIG. 5) of the next cell separating element 10, for example can be provided as a corresponding embossment in the peripheral area 12b thereof or in the area of the shell periphery R (cf. FIG. 2).

FIG. 5 shows a schematic representation of a flap 34 for a cell separating element 10 according to a further execution example. It in turn comprises a certain locking geometry 60 in the end area 34a, which can be coupled to or can be locked into a corresponding locking geometry 62 of a cell separating element 10 adjacent in y-direction For example, it can be provided by a suitable flap 34′ of the further cell separating element 10, which is in turn provided by a partial area of the second peripheral area 22b of the second wall 22. Alternatively, it can also be formed as a suitable notch in the shell periphery R as mentioned above.

Such an overlapping or protruding end 34a of the flap 34 of the cell separating element 10 can be configured such that it can lock into a geometry 62 of the next cell separating element 10 provided thereto, e.g. as soon as the battery cell units 14 of a cell stack are pressed to each other in the assembly. Thereby, a higher stiffness of the overall construction advantageously results. This could be implemented in swelling direction, which corresponds to the illustrated y-direction, but also transversely to the swelling direction y, that is for example with respect to the x-direction. This offers an advantage upon lateral shock effect. Overall, the mechanical stability of the overall construction in x-, y- and z-direction can be increased. Therein, FIG. 5 in particular shows locking geometries 60, 62 of the cell separating elements 10, which allow a closed component cluster and thereby an increase of the stiffness of the overall construction.

FIG. 6 shows a schematic representation of a battery cell unit 14 with a cell separating element 10 according to a further execution example of the invention. In particular, it can be formed as previously described, in particular with the differences or particularities described below: In this case, the cell separating element 10 is in turn configured with a flap 34, which exemplarily extends across the entire width or substantially the entire width of the pad 12 with respect to the illustrated x-direction. In addition, the flap 34 also extends across the entire width of the side 42 of the cell 16 in y-direction. The end 34a is in turn formed with a spacer 58, but which presently has a substantially round geometry and not a hook-shaped geometry. Thereby, the stiffness of the spacer 58 can be increased. This spacer 58 can additionally be conceived such that it does not collide with the pad 12 of the next cell separating element 10, on which it comes into abutment in the cell stack. In particular, it or the pad 12 can be dimensioned and positioned such that the spacer 58 comes into abutment in the peripheral area 12b of the next cell separating element 10 in the cell stack.

If the flap 34 covers a large part or major part or nearly the entire housing side 42 at the same time, thus, the further advantage results from it that an additional protective function of a neighbor cell of the present cell 16 from the hot fire jet of the thermal runaway cell 16 is provided if the housing 38 thereof should open in the area covered by the cell separating element 10, in particular in the area of the second housing side 42.

These respective previously described particular formations of the end area 32a of such a flap 34 and in particular the protrusion beyond the cell 16 in y-direction by the flap 34 allow providing many advantageous functions. Hereby, it is for example possible to fix the cell separating element 10 onto the cell 16, e.g. by configuration of the flap ends 34a in the form of for example a snap connection 52. Therein, the legs, i.e. flaps 34, can be as wide with respect to their width in x-direction as the remaining cell separating element 10 or the pad 12 or the second part 30b, 32b of the respective walls 20, 22, or they can also be shorter or less wide. Additionally or alternatively, the ends 34a can also be configured, in particular with respect to shape and/or thickness, such that they form an elastic frame function 58 to the next cell 16 or cell unit 14 at the same time. This can also be implemented across the entire width of the cell separating element 10 with respect to the x-direction or else only across a partial length with respect to the x-direction. In addition, this offers the advantage to realize the frame 58 provided by the spacer 54 with a certain spring force, as it is exemplarily illustrated by means of the illustrated V-shape of the hook 54. However, other geometries are also suitable hereto. In addition, the cell separating element 10 can be locked to a further cell separating element 10 via locking geometries 60, 62.

Overall, the examples show how a cell separating element with a pressure cooling pad and integrated fixing can be provided by the invention.

A description has been provided with particular reference to examples, but it will be understood that variations and modifications can be effected within the spirit and scope of the claims, which may include the phrase “at least one of A, B and C” as an alternative expression that refers to one or more of A, B or C, contrary to the holding in Superguide v. DIRECTV, 358 F3d 870, 69 USPQ2d 1865 (Fed. Cir. 2004).

1. A cell separating element for arrangement at a prismatic battery cell, comprising:
a first wall and a second wall opposing the second wall, between which the first wall and the second wall a cavity filled or fillable with a fluid is formed to provide a pad filled or fillable with the fluid,
so that the cell separating element is divided into a pad area of the pad and a cell separating element peripheral area surrounding the pad area in a closed manner in a circumferential direction,
wherein,
the cell separating element peripheral area delimits the pad in and opposite to a first direction (x) and in and opposite to a second direction (z), and which includes a first peripheral area of the first wall and a second peripheral area of the second wall (22),
the first wall and the second wall are connected to each other in the cell separating element peripheral area, and
the first peripheral area includes a first part that is an attachment flap arranged angled at an angle (α) to a second part of the first peripheral area adjoining to the pad area, so that the cell separating element is retainable on or attachable to the prismatic battery cell by the attachment flap.

2. The cell separating element according to claim 1, wherein
the first part of the first peripheral area is arranged at the angle (α) so that, when the pad area of the cell separating element is arranged on a first housing side of the prismatic battery cell, the first part of the first peripheral area is flatly abutted or placed on a second housing side adjoining to the first housing side, of the prismatic battery cell.

3. The cell separating element according to claim 1,
wherein
the second peripheral area includes a first part that is an attachment flap, so that the attachment flap of the first peripheral area and the attachment flap of the second peripheral area are a plurality of attachment flaps, which are each formed as the first part of the first peripheral area and/or the second peripheral area, and
a first attachment flap and a second attachment flap, among the plurality of attachment flaps, are arranged on opposing sides of the pad with respect to the first direction (x) or the second direction (z).

4. The cell separating element according to claim 1, wherein the first part of the first peripheral area is as wide as the second part of the first peripheral area or less wide than the second part of peripheral area.

5. The cell separating element according to claim 3, wherein
an attachment flap, among the plurality of attachment flaps, includes a first locking element, which, when the pad area is arranged on a first housing side of the prismatic battery cell, is lockingly coupled to a corresponding second locking element of a second housing side adjoining to the first housing side of the prismatic battery cell.

6. The cell separating element according to claim 5, wherein
the attachment flap is formed with a spacer at a flap end of the attachment flap, the attachment flap, when the pad area is arranged on the first housing side of the prismatic battery cell, protrudes beyond the prismatic battery cell in a third direction (y).

7. The cell separating element according to claim 6, wherein
the spacer is formed as a hook folded on an end side, which, upon arrangement of the pad area on the first housing side, encompasses onto a third housing side which adjoins to the second housing side, of the prismatic battery cell and opposes the first housing side.

8. The cell separating element according to claim 7, wherein the prismatic battery cell is arrangeable adjacent to one other prismatic battery cell with a third locking element configured to lock with a locking element of a locking geometry, and the attachment flap comprises a fourth locking element with the locking geometry at the flap end of the attachment flap to lock into the third locking element of the one other prismatic battery cell.

9. A prismatic battery arrangement of a plurality of prismatic batteries, each prismatic battery of the plurality of prismatic batteries with a cell separating element according to claim 1.

10. A method of producing a cell separating element for arrangement at a prismatic battery cell, comprising:
forming a first wall and a second wall opposing the first wall, between which the first wall and the second wall a cavity filled or fillable with a fluid is formed to provide a pad filled or fillable with the fluid,
so that the cell separating element divides into a pad area of the pad and a cell separating element peripheral area surrounding the pad area in a closed manner in a circumferential direction,
wherein,
the cell separating element peripheral area delimits the pad in and opposite to a first direction (x) and in and opposite to a second direction (z), and which includes a first peripheral area of the first wall and a second peripheral area of the second wall,
the first wall and the second wall are connected to each other in the cell separating element peripheral area, and
forming an attachment flap configured as a first part of the first peripheral area and angled at an angle (α) to a second part of the first peripheral area that adjoins the pad area and situated in a pad plane of the pad, so that the cell separating element is retainable on or attachable to the prismatic battery cell by the attachment flap.
